(19) United States
(12) Patent Application Publication
(10) Pub. No.: US 2026/0082451 A1
(43) Pub. Date: Mar. 19, 2026

(54) PLANAR HEATER AND REFRIGERATOR INCLUDING THE SAME

(71) Applicant: SAMSUNG ELECTRONICS CO., LTD., Suwon-si (KR)

(72) Inventors: Sungmin CHO, Suwon-si (KR); Seokhyeon KANG, Suwon-si (KR); Moojin KWAK, Suwon-si (KR); Kyoungmok KIM, Suwon-si (KR); Choongkeon KIM, Suwon-si (KR); Junhan BAE, Suwon-si (KR); Inseon OH, Suwon-si (KR); Sooyoung YU, Suwon-si (KR); Minkyung LEE, Suwon-si (KR); Juhyen LEE, Suwon-si (KR); Yongjoon JANG, Suwon-si (KR); Donggi HAN, Suwon-si (KR)

(73) Assignee: SAMSUNG ELECTRONICS CO., LTD., Suwon-si (KR)

(21) Appl. No.: 19/313,083

(22) Filed: Aug. 28, 2025

Related U.S. Application Data
(63) Continuation of application No. PCT/KR2025/006866, filed on May 21, 2025.

(30) Foreign Application Priority Data
Sep. 13, 2024 (KR) 10-2024-0126180
Oct. 31, 2024 (KR) 10-2024-0152969

(51) Int. Cl. H05B 3/26; F25D 21/08

(52) U.S. Cl. CPC H05B 3/26; F25D 21/08; H05B 2214/02

(57) ABSTRACT

A planar heater of a cooling device may include a heating layer, a pair of insulating film layers respectively arranged on front and rear surfaces of the heating layer and configured to insulate the heating layer, and a film protection layer configured to protect the pair of insulating film layers and to externally transfer heat transferred from the pair of insulating film layers.

### CROSS-REFERENCE TO RELATED APPLICATIONS

This application is a continuation of International Application No. PCT/KR2025/006866 filed May 21, 2025, and claims foreign priority to Korean Application No. 10-2024-0126180 filed Sep. 13, 2024, and Korean Application No. 10-2024-0152969 filed Oct. 31, 2024. International Application No. PCT/KR2025/006866, Korean Application No. 10-2024-0126180, and Korean Application No. 10-2024-0152969 are incorporated herein by reference in their entireties.

### TECHNICAL FIELD

The disclosure relates to a planar heater and a refrigerator including the same.

### BACKGROUND ART

A refrigeration cycle is a cycle that cools a specific object or space through a thermodynamic process of absorbing heat at low temperature and low pressure and releasing heat at high temperature and high pressure by using a refrigerant, which is a substance that changes sensitively to temperature and pressure.

A refrigeration cycle may be performed by a system including a compressor that compresses a low-temperature low-pressure gaseous refrigerant into a high-temperature high-pressure gaseous refrigerant, a condenser that cools the high-temperature high-pressure gaseous refrigerant to make a high-temperature high-pressure liquid refrigerant, an expander that changes the high-temperature high-pressure liquid refrigerant to a low-temperature low-pressure liquid refrigerant, and an evaporator that absorbs ambient heat to make a low-temperature low-pressure gaseous refrigerant.

The property of absorbing ambient heat while changing the low-temperature low-pressure liquid refrigerant to the low-temperature low-pressure gaseous refrigerant may be utilized in cooling devices, for example, air conditioners and refrigerators.

In an initial operation of a cooling device, a cooler, which is an indoor unit, may also remove moisture while cooling air of a refrigerator at room temperature. When a temperature inside a cooling device is approximately 5° C. or less, a temperature of an evaporator mounted on a cooler may drop below zero, causing moisture in the air to condense. Accordingly, the evaporator provided in the cooling device freezes. This is referred to as frost formation.

When frost formation occurs on the evaporator of the cooling device, cooling performance deteriorates, and when frost formation becomes severe, frost builds up like snow inside the evaporator, making cooling difficult. Therefore, frost formed on the evaporator included in the cooling device has to be removed periodically. This is referred to as defrosting.

For the purpose of defrosting, the cooling device may include a planar heater arranged adjacent to the evaporator.

### DISCLOSURE

### Technical Solution

A planar heater according to an embodiment of the disclosure may include a heating layer, a front insulating film layer with an inner surface on front surface of the heating layer, and a rear insulating film layer with an inner surface on the rear surface of the heating layer. The front insulating film layer and the rear insulating film layer are also together referred to herein as a pair of insulating film layers.

The planar heater according to an embodiment of the disclosure may further include a front film protection layer on an outer surface of the front insulating film layer configured to externally transfer heat transferred from the front insulating film layer and a rear film protection layer on an outer surface of the rear insulating protection layer configured to transfer heat from the rear insulating film layer. The front film protection layer and the rear film protection layer are also together referred to herein as the film protection layer.

The front insulating film layer and the rear insulating film layer together electrically insulate the heating layer, and the front film protection layer and the rear film protection layer together protect the front insulating layer, the rear insulating layer, and the heating layer from damage caused by collisions during transportation and installation of the planar heater and damage caused by exposure to moisture where the planar heater is installed.

A refrigerator according to an embodiment of the disclosure may include a body portion having at least one storage compartment and a door configured to open or close the at least one storage compartment, and an evaporator provided in the body portion and configured to supply cold air to the at least one storage compartment.

The evaporator may include an evaporator module including a refrigerant tube through which a refrigerant moves and cooling fins arranged on an outer circumferential surface of the refrigerant tub.

The evaporator according to an embodiment of the disclosure may further include the above-described planar heater arranged adjacent to the evaporator module and configured to heat the evaporator module.

### DESCRIPTION OF DRAWINGS

FIG. 1 is a front view of a cooling device according to an embodiment of the disclosure.

FIG. 2 is a front view of a cooling device in which a door is opened, according to an embodiment of the disclosure.

FIG. 3 is a schematic diagram of a cooling device according to an embodiment of the disclosure.

FIG. 4 is a perspective view of an evaporator according to an embodiment of the disclosure.

FIG. 5 is an example of an exploded perspective view of an evaporator according to an embodiment of the disclosure.

FIG. 6 is another example of an exploded perspective view of an evaporator according to an embodiment of the disclosure.

FIG. 7 is an exploded perspective view of a planar heater according to an embodiment of the disclosure.

FIG. 8 is an example of a schematic cross-sectional view of a planar heater according to an embodiment of the disclosure.

FIG. 9 is a schematic diagram of a planar heater according to an embodiment of the disclosure.

FIG. 10 is an example of a schematic cross-sectional view of a planar heater according to an embodiment of the disclosure.

FIG. 11 is an example of a schematic cross-sectional view of a planar heater according to an embodiment of the disclosure.

FIG. 12 is a diagram illustrating an example of a cross-sectional structure of a planar heater according to an embodiment of the disclosure.

FIG. 13 is a perspective view illustrating an example of a planar heater according to an embodiment of the disclosure.

FIG. 14 is a diagram illustrating a state before bending of the shape of the planar heater of FIG. 13.

### MODE FOR INVENTION

Various embodiments of the disclosure and terms as used therein are not intended to limit the technical features described in the disclosure to specific embodiments and should be understood as including various modifications, equivalents, or alternatives of the embodiments.

In connection with the description of the drawings, like reference numbers may be used to denote like or related elements.

A singular form of a noun corresponding to an item may include one or more items, unless the relevant context clearly indicates otherwise.

In the disclosure, the expressions such as “A or B,” “at least one of A and B,” “at least one of A or B,” “A, B, or C,” “at least one of A, B, and C,” and “at least one of A, B, or C” may include any one of the items listed in the corresponding expression or all possible combinations thereof.

The terms “first,” “second,” etc. as used herein may be only used to distinguish one element from another and do not limit the elements in any other aspects (e.g., importance or order).

When a certain (e.g., first) element is referred to as being “coupled” or “connected” to another (e.g., second) element with or without the terms “functionally” or “communicatively,” it means that the certain element may be coupled or connected to the other element directly (e.g., by wire) or wirelessly or through a third element.

The terms “comprise” or “include” as used herein are inclusive and therefore specify the presence of stated features, integers, steps, operations, elements, components, or combinations thereof, but do not preclude the presence or addition of one or more other features, integers, steps, operations, elements, components, or combinations thereof.

It will be understood that when an element is referred to as being “connected to,” “coupled to,” “supported to,” or “in contact with” another element, the element may be “directly connected to, coupled to, supported to, or in contact with” the other element or may be “indirectly connected to, coupled to, supported to, or in contact with” the other element through a third element.

It will be understood that when an element is referred to as being located “on” another element, the element may be in contact with the other element, and another element may also be present between the two elements.

The term “and/or” as used herein includes a combination of a plurality of related recited elements or any one of a plurality of related recited elements.

Hereinafter, the operating principle and embodiment of the disclosure are described with reference to the accompanying drawings.

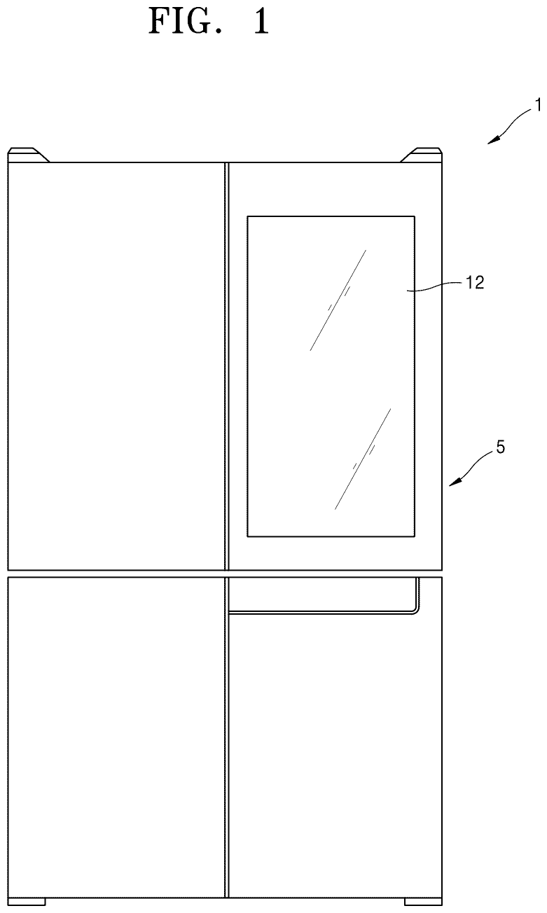

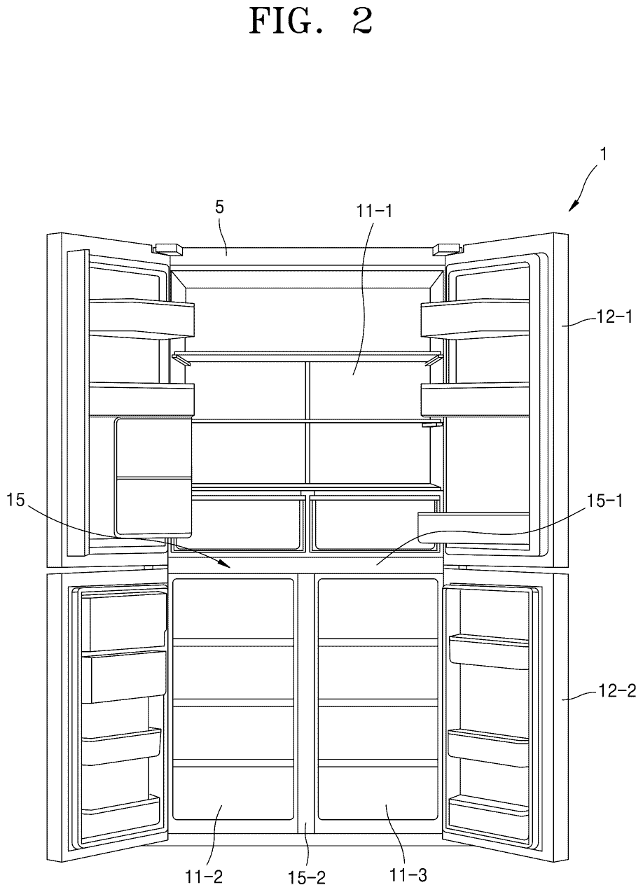

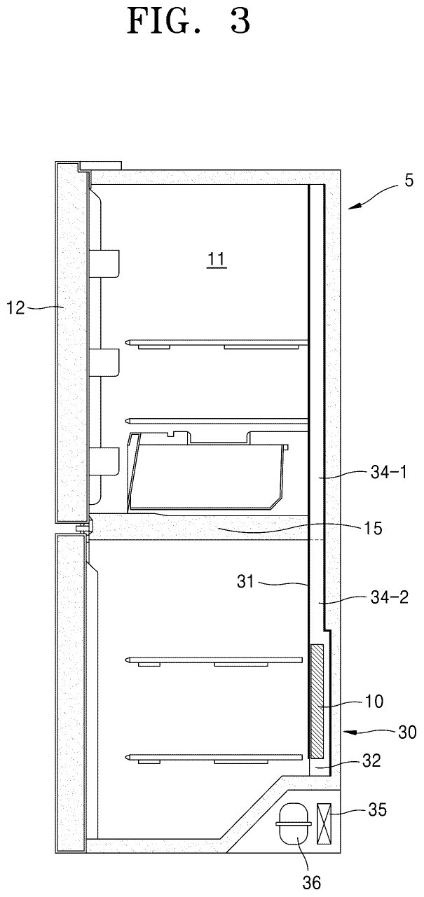

FIG. 1 is a front view of a cooling device 1 according to an embodiment of the disclosure. FIG. 2 is a front view of the cooling device 1 in which a door 12 is opened, according to an embodiment of the disclosure. FIG. 3 is a schematic diagram of the cooling device 1 according to an embodiment of the disclosure.

The cooling device 1 according to an embodiment of the disclosure may implement a refrigeration cycle that cools a specific object or space through a thermodynamic process of absorbing heat at low temperature and low pressure and releasing heat at high temperature and high pressure by using a refrigerant, which is a substance that changes sensitively to temperature and pressure.

According to an embodiment of the disclosure, as illustrated in FIGS. 1 to 3, the cooling device 1 may be a refrigerator capable of cooling goods accommodated in a storage compartment 11. However, the disclosure is not limited thereto, and the cooling device 1 described in the disclosure may be any cooling device (e.g., an air conditioner, a refrigerator, a freezer, etc.) which includes an evaporator 10 through which a refrigerant absorbing heat from a fluid to be cooled moves and in which frost may be formed on the evaporator 10 by moisture included in air introduced from the outside. In the following description, it is assumed that the cooling device 1 according to an embodiment of the disclosure is a refrigerator.

According to an embodiment of the disclosure, the cooling device 1 may include a body portion 5. The body portion 5 may form the exterior of the cooling device 1. The body portion 5 may include at least one storage compartment 11 and a door 12 that opens or closes the storage compartment 11.

The storage compartment 11 may be divided into a plurality of compartments by a partition portion 15, and a plurality of shelves and storage containers may be arranged inside the storage compartment 11 so as to store food or the like therein. The storage compartment 11 may be divided into a plurality of storage compartments by the partition portion 15. The partition portion 15 may include a first partition portion 15-1 that is horizontally connected to the storage compartment 11 to divide the storage compartment 11 into an upper storage compartment 11-1 and lower storage compartments 11-2 and 11-3, and a second partition wall 15-2 that is vertically connected to the lower storage compartments 11-2 and 11-3 to divide the lower storage compartments 11-2 and 11-3.

The first partition portion 15-1 and the second partition portion 15-2 may be coupled to each other to form a T-shaped partition portion 15, which may divide the storage compartment 11 into three spaces. Among the upper storage compartment 11-1 and the lower storage compartments 11-2 and 11-3 formed by the first partition portion 15-1, the upper storage compartment 11-1 may be used as a refrigerating compartment and the lower storage compartments 11-2 and 11-3 may be used as freezing compartments.

The division of the storage compartment 11 is only an example, and the respective storage compartments may be used differently from the above description.

The storage compartment 11 may be opened or closed by a plurality of doors 12. The plurality of doors 12 may be spaced apart from each other by predefined intervals. As an example, the plurality of doors 12 may be arranged on the front of the body portion 5 and may open or close an opening provided in the body portion 5.

The upper storage compartment 11-1 may be opened or closed by an upper door 12-1 that is rotatably coupled to the body portion 5 in which the storage compartment 11 is provided. The lower storage compartments 11-2 and 11-3 may be respectively opened or closed by upper doors 12-2 that are rotatably coupled to the body portion 5 in which the storage compartment 11 is provided.

The evaporator 10 may be provided in the body portion 5 to supply cold air to the storage compartment 11. A cooling compartment 30 including the evaporator 10 and a blower fan (not shown) may be provided on the rear side of the storage compartment 11. A storage compartment return duct 32 may be arranged in a partition wall 31 so that air inside the storage compartment 11 may be sucked in and returned to the cooling compartment 30. In addition, cold air ducts 34-1 and 34-2 each having a plurality of cold air discharge ports (not shown) in the front side may be installed on the rear side of the storage compartment 11. A condenser 35, an expander (not shown), and a compressor 36 may be provided in the body portion 5. The condenser 35 may convert high-temperature high-pressure gaseous refrigerant into high-temperature high-pressure liquid refrigerant. The expander (not shown) may convert high-temperature high-pressure liquid refrigerant into low-temperature low-pressure liquid refrigerant. The compressor 36 may convert low-temperature low-pressure gaseous refrigerant into high-temperature high-pressure gaseous refrigerant.

As the cooling device 1 according to an embodiment of the disclosure, a bottom-type cooling device in which the refrigerating compartment is located at the top and the freezing compartment is located at the bottom has been described, but the disclosure may also be applied to a top-type cooling device in which the refrigerating compartment is located at the bottom and a side-by-side-type cooling device 1 in which the freezing compartment and the refrigerating compartment are located on the left/right sides of the body portion 5.

As an example, air in the storage compartment 11 is sucked into the cooling compartment 30 through the storage compartment return duct 32 of the partition wall 31 by the blower fan (not shown) of the cooling compartment 30, is heat-exchanged with the evaporator 10, and is then discharged to the storage compartment 11 through the cold air discharge ports (not shown) of the cold air ducts 34-1 and 34-2. This process is repeated. At this time, frost may be formed on the surface of the evaporator 10 due to a temperature difference from circulating air that is re-introduced through the storage compartment return duct 32.

When frost formation occurs on the evaporator 10, a flow velocity of the circulating air re-introduced into the evaporator 10 may decrease. Accordingly, because the cooling performance of the cooling device 1 may deteriorate, the frost formed on the evaporator 10 has to be removed periodically.

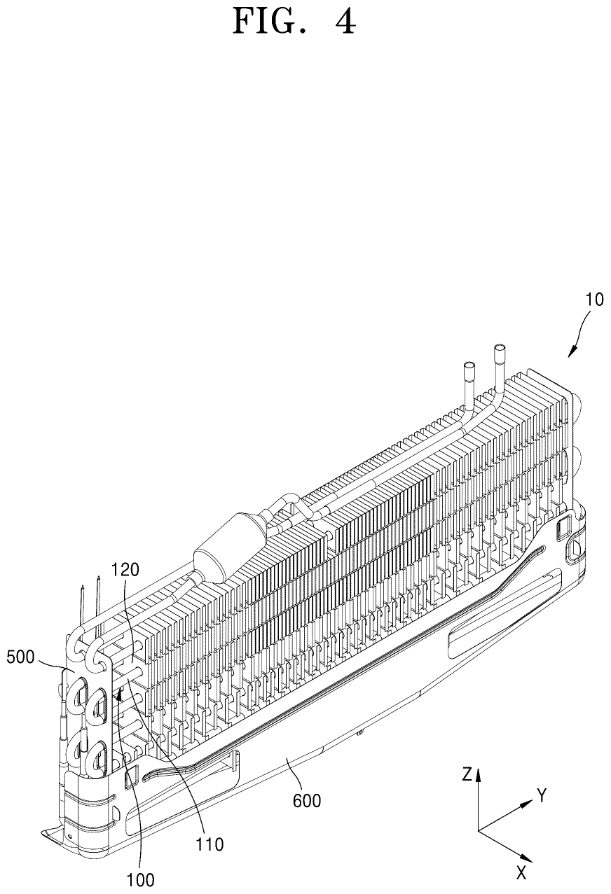

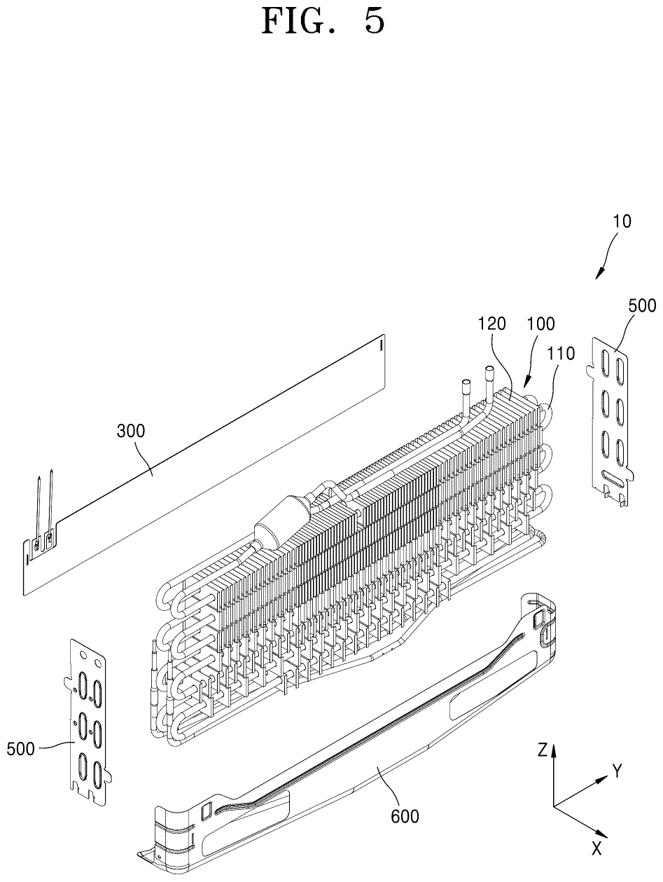

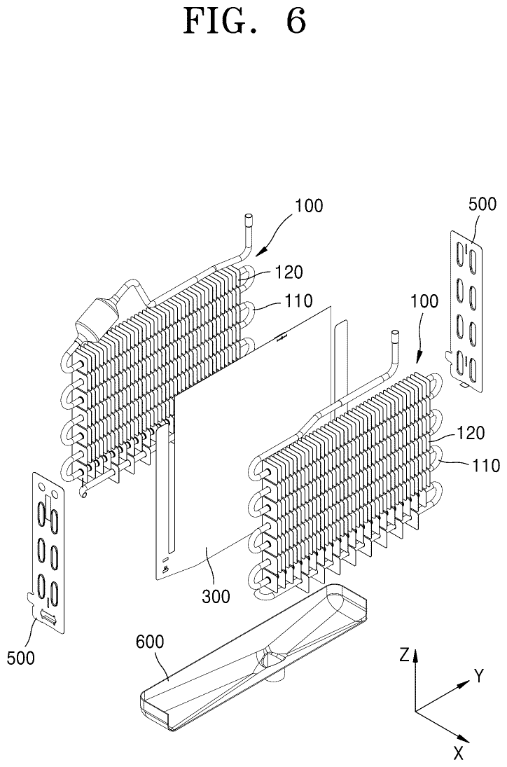

FIG. 4 is a perspective view of the evaporator 10 according to an embodiment of the disclosure. FIG. 5 is an example of an exploded perspective view of the evaporator 10 according to an embodiment of the disclosure. FIG. 6 is another example of an exploded perspective view of the evaporator 10 according to an embodiment of the disclosure.

Referring to FIGS. 4 and 5, the evaporator 10 according to an embodiment of the disclosure may include an evaporator module 100, a planar heater 300 arranged on at least one surface of the evaporator module 100, brackets 500 supporting the evaporator module 100 and the planar heater 300, and a drain portion 600 arranged below the evaporator module 100.

In the following description, a first direction X refers to a thickness direction of the evaporator 10 or an arrangement direction of the planar heater 300 and the evaporator module 100. The first direction X may be referred to as a front-and-back direction. A second direction Z refers to a direction perpendicular to the first direction X among the directions parallel to a plane along which the planar heater 300 extends, for example, a longitudinal direction of the evaporator 10. A third direction Y refers to a width direction of the evaporator 10.

The evaporator module 100 may include a refrigerant tube 110 through which a refrigerant moves and a plurality of cooling fins 120 arranged on the outer circumferential surface of the refrigerant tube 110. The refrigerant tube 110 may be repeatedly bent in zigzags to form a plurality of steps (columns) and may be filled with the refrigerant. As an example, the refrigerant tube 110 may include an aluminum material, but the disclosure is not limited thereto.

The refrigerant tube 110 may be a combination of horizontal pipe portions and bent pipe portions. The horizontal pipe portions may be arranged horizontally from top to bottom to form a plurality of steps (columns), and the horizontal pipe portions of the respective steps (columns) may configured to pass through the plurality of cooling fins 120. The bent pipe portion may be configured to communicate the upper horizontal pipe portion with the lower horizontal pipe portion by connecting an end of the upper horizontal pipe portion to an end of the lower horizontal pipe portion.

The refrigerant tube 110 may be supported by passing through the brackets 500 provided respectively on left and right sides of the evaporator 10. In this case, the bent pipe portion of the refrigerant tube 110 may be configured to connect the end of the upper horizontal pipe portion to the end of the lower horizontal pipe portion at the outside of the bracket 500.

In the refrigerant tube 110, the plurality of cooling fins 120 may be spaced apart from each other by predefined intervals along the extension direction of the refrigerant tube 110. The plurality of cooling fins 120 may include a flat plate made of aluminum, but the disclosure is not limited thereto. For example, the plurality of cooling fins 120 may include a flat plate including any material having high thermal conductivity. By expanding the size of the refrigerant tube 110 to fit insertion holes of the plurality of cooling fins 120 in a state where the refrigerant tube 110 is inserted into the insertion holes of the plurality of cooling fins 120, the refrigerant tube 110 may be firmly supported in the insertion holes.

The evaporator 10 according to an embodiment of the disclosure may be implemented in an arrangement structure in which the refrigerant tubes 110 are respectively arranged at the front and rear sides of the evaporator 10.

According to an embodiment of the disclosure, in FIGS. 4 and 5, the front refrigerant tube 110 and the rear refrigerant tube 110 may have the same shape. However, the disclosure is not limited thereto. The front refrigerant tube 110 and the rear refrigerant tube 110 may have different shapes. In addition, the front refrigerant tube 110 and the rear refrigerant tube 110 may be connected to each other so that the same refrigerant may move along the front refrigerant tube 110 and the rear refrigerant tube 110.

In the evaporator 10 according to an embodiment of the disclosure, the planar heater 300 may extend along a plane (YZ plane) perpendicular to the first direction (X direction). As an example, the planar heater 300 may have a plate shape extending along a plane (YZ plane). The thickness of the planar heater 300 may be 300 mm to 800 mm. For example, the planar heater 300 may transfer heat toward at least one of a front direction (+X direction) or a rear direction (−X direction) of the extended plane (YZ plane).

The planar heater 300 may be arranged on at least one surface of the evaporator module 100. As illustrated in FIG. 5, the planar heater 300 may be arranged to face the rear surface of the evaporator module 100. The planar heater 300 may release heat toward the rear surface of the evaporator module 100.

As illustrated in FIG. 6, in the evaporator 10 according to an embodiment of the disclosure, the planar heater 300 may be arranged between the evaporator modules 100. By releasing heat toward the front and rear directions, the planar heater 300 may remove frost formed on the evaporator modules 100 respectively arranged to face the front and rear surfaces of the planar heater 300.

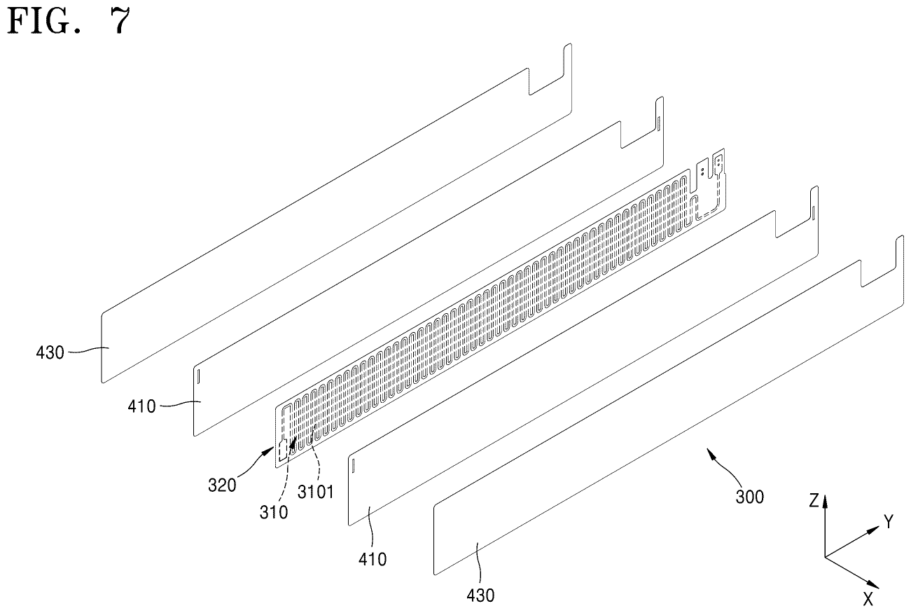

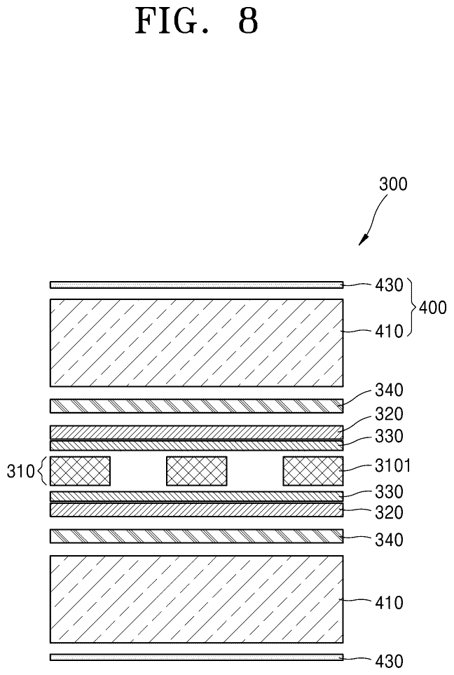

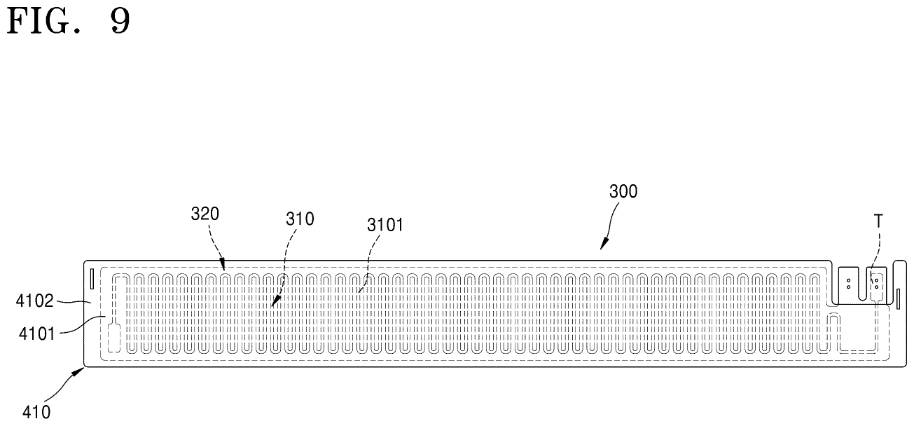

FIG. 7 is an exploded perspective view of the planar heater 300 according to an embodiment of the disclosure. FIG. 8 is a schematic cross-sectional view of the planar heater 300 according to an embodiment of the disclosure. FIG. 9 is a schematic diagram of the planar heater 300 according to an embodiment of the disclosure.

Referring to FIGS. 7 and 8, the planar heater 300 may include a heating layer 310 and a pair of insulating film layers 320 configured to insulate the heating layer 310.

The heating layer 310 may include a heating material 3101. The heating material 3101 may include at least one of a graphene material, silver nano ink (Ag nano paste), indium tin oxide (ITO), austenite stainless steel sheet, palladium, or copper (Cu). For example, the heating material 3101 may include a graphene material. For example, the heating material 3101 may include at least one of graphene flake or chemical vapor deposition (CVD) graphene.

When the heating material 3101 includes a graphene material, high output of the planar heater 300 may be induced through the low resistivity of the graphene. In addition, when the heating material 3101 includes a graphene material, rapid heating may be induced because the resistance of the graphene material decreases as the temperature increases. On the other hand, when the heating material 3101 includes graphene flake, a price competitiveness may be ensured unlike the CVD graphene because graphene flake may be formed without a deposition process.

The heating layer 310 may have a predefined thickness or less. For example, the thickness of the heating layer 310 may be 120 μm or less. For example, the thickness of the heating layer 310 may be 40 μm to 120 μm. For example, the thickness of the heating layer 310 may be 1 nm or less. The thickness of the heating layer 310 may vary depending on the heating material 3101. For example, when the heating material 3101 of the heating layer 310 is graphene flake, the thickness of the heating layer 310 may be 40 μm to 120 μm. For example, when the heating material 3101 of the heating layer 310 is CVD graphene, the thickness of the heating layer 310 may be 1 nm or less.

In the heating layer 310, the heating material 3101 may be arranged in a predefined shape. The heating material 3101 of the heating layer 310 may be arranged in a line shape or a plane shape. For example, as illustrated in FIG. 9, the heating material 3101 of the heating layer 310 may have a line shape extending in zigzags. However, the arrangement form of the heating material 3101 of the disclosure is not limited thereto, and the heating material 3101 may be variously arranged on the same plane.

As electric current is supplied to the heating material 3101 through a terminal T, the heating layer 310 may generate heat. Whether to operate the heating layer 310 may be controlled by a processor.

The insulating film layers 320 may be arranged on the front and rear surfaces of the heating layer 310 so as to insulate the heating layer 310.

The insulating film layer 320 may have a plate shape extending along a plane (YZ plane) corresponding to the planar heater 300. The insulating film layer 320 may have heat resistance up to a heating temperature applied by the heating layer 310. For example, the insulating film layer 320 may have heat resistance up to a heating temperature of 150° C.

The insulating film layer 320 may be determined by taking into account insulation, heat resistance, and heat capacity. As an example, the insulating film layer 320 may include an insulating material. For example, the insulating film layer 320 may include polymer. For example, the insulating film layer 320 may include at least one of polyimide or polyester. The insulating film layer 320 may include polyimide by taking into account small heat capacity.

For example, the insulating film layer 320 may have a thin-film shape having a thickness of 50 μm to 125 μm. When the thickness of the insulating film layer 320 is less than 50 μm, it may be difficult to ensure an insulating function. When the thickness of the insulating film layer 320 is greater than 125 μm, cracks may occur due to the difference in thermal expansion coefficient between materials included in the insulating film layer 320 and the planar heater 300.

An adhesive layer 330 may be arranged between the heating layer 310 and the insulating film layer 320. A portion of the adhesive layer 330 may be arranged between the heating materials 3101 of the heating layer 310. The heating layer 310 may be fixed to the insulating film layer 320 by the adhesive layer 330. As an example, because the adhesive layer 330 may also receive heat applied from the heating layer 310, an adhesive material included in the adhesive layer 330 may have heat resistance up to a heating temperature of 150° C. For example, the adhesive material included in the adhesive layer 330 may include at least one of a silicone-based adhesive material or an acrylic-based adhesive material.

However, when the insulating film layer 320 for insulating the heating layer 310 is directly exposed to the outside of the planar heater 300, the insulating film layer 320 may be damaged during a process of transporting or using the planar heater 300.

For example, during a process of transporting the planar heater 300, the insulating film layer 320 may collide with surrounding structures or surrounding components. For example, in a process of moving the planar heater 300 so as to install the planar heater 300 in the evaporator 10, the insulating film layer 320 of the planar heater 300 may collide with the cooling fins 120 or may be scratched by the cooling fins 120. In this case, a portion of the insulating film layer 320 may be damaged. When the heating material 3101 of the heating layer 310 is exposed to the outside through the damaged insulating film layer 320, this may cause a fire.

For example, in a process of using the planar heater 300 or the evaporator 10 including the same, the planar heater 300 may be exposed to moisture. For example, when a polymer-based material is used as the material of the insulating film layer 320 and the insulating film layer 320 is directly exposed to moisture, the insulating film layer 320 may not be able to completely block moisture penetration into the heating layer 310. Accordingly, moisture may permeate or flow into the heating layer 310 through the insulating film layer 320. Due to the introduced moisture, the shape of the heating material 3101 of the heating layer 310 may change, or voids may be formed in the heating layer 310. For example, moisture introduced into the heating layer 310 may evaporate, and thus, an empty space may be formed in the heating layer 310. The empty space formed in the heating layer 310 may change the arrangement or shape of the heating material 3101. Due to the empty space of the heating layer 310 and the shape deformation of the heating material 3101, the heating layer 310 may locally increase in resistance or cause excessive current to flow. Due to this, the heating layer 310 may be locally overheated or sparks may occur, which may cause damage to the insulating film layer 320. The introduction of moisture through the insulating film layer 320 may also cause damage to the insulating film layer 320.

Referring to FIGS. 7 to 9, by taking into account the possibility of damage to the insulating film layer 320, the planar heater 300 according to an embodiment of the disclosure may further include a film protection layer 400 configured to protect the insulating film layer 320 and transfer heat to the outside.

The film protection layer 400 may further include a front metal protection layer and a rear metal protection layer, together referred to as metal protection layers 410 respectively arranged on the outer surfaces of the insulating film layers 320. The metal protection layers 410 may be respectively arranged on the outer surfaces of the pair of insulating film layers 320.

The metal protection layer 410 may include a material with high thermal conductivity to protect the insulating film layer 320 and to externally transfer heat transferred through the insulating film layer 320. For example, the metal protection layer 410 may include a metal material with high thermal conductivity. For example, the metal protection layer 410 may include aluminum. Because the metal protection layer 410 includes a metal material, the metal protection layer 410 may block the transfer of moisture from the outside to the insulating film layer 320. However, the material of the metal protection layer 410 is not limited thereto, and various metal materials with high thermal conductivity may be used.

As described above, the planar heater may reduce scratches from the outside through the metal protection layers 410 respectively arranged on the outer surfaces of the insulating film layers 320 and may prevent moisture from permeating into the heating layer 310.

Referring to FIGS. 7 and 9, the metal protection layer 410 may be configured to cover the insulating film layer 320. For example, the size of the metal protection layer 410 may be greater than the size of the insulating film layer 320. The metal protection layer 410 may include an overlapping region 4101 that overlaps the insulating film layer 320 and a non-overlapping region 4102 that does not overlap the insulating film layer 320. The non-overlapping region 4102 may be arranged on the edge of the overlapping region 4101.

The width of the non-overlapping region 4102 may be 0.1 mm or more. For example, the width of the non-overlapping region 4102 may be 1 mm to 5 mm. The inclusion of the non-overlapping region 4102 may increase a movement path of moisture permeating between the metal protection layers 410. The width of the non-overlapping region 4102 may be constant or may vary depending on a position. When the width of the non-overlapping region 4102 varies depending on a position, the width of the non-overlapping region 4102 may be an average of the entire widths of the non-overlapping region 4102.

The metal protection layer 410 may be configured to perform a function of maintaining the shape of the planar heater 300. As an example, the thickness of the metal protection layer 410 may be greater than or equal to a predefined thickness. For example, the thickness of the metal protection layer 410 may be 0.15 mm or more. Because the metal protection layer 410 has a predefined thickness, the planar heater 300 may maintain a flat shape. Accordingly, the workability of the planar heater 300, such as the arrangement and transport of the planar heater 300, may be improved during a process of manufacturing the evaporator 10. On the other hand, by taking into account the small heat capacity of the metal protection layer 410, the thickness of the metal protection layer 410 may be 0.3 mm or less. For example, the thickness of the metal protection layer 410 may be 0.15 mm to 0.3 mm.

The material and thickness of the metal protection layer 410 may be determined by taking into account the material and thickness of the surrounding object, for example, the material and thickness of the cooling fins (see 120 of FIG. 5). For example, the metal protection layer 410 may include a material having a strength greater than or equal to a strength of the cooling fin 120 and may have a thickness greater than or equal to a thickness of the cooling fin 120. For example, when the material of the cooling fin 120 includes aluminum and the thickness of the cooling fin 120 is 0.15 mm, the material of the metal protection layer 410 may include aluminum and the thickness of the metal protection layer 410 may be 0.15 mm or more.

An adhesive layer 340 may be arranged between the metal protection layer 410 and the insulating film layer 320. The metal protection layer 410 may be adhered to the insulating film layer 320 by the adhesive layer 340. An adhesive material included in the adhesive layer 340 may have heat resistance up to a heating temperature of 150° C. For example, the adhesive material included in the adhesive layer 340 may include at least one of a silicone-based adhesive material or an acrylic-based adhesive material.

The metal protection layers 410 respectively arranged on the outer surfaces of the pair of insulating film layers 320 may have the same thickness and material. However, the metal protection layers 410 respectively arranged on the outer surfaces of the pair of insulating film layers 320 may not necessarily have the same thickness and material, and at least one of the thickness or material may be different when necessary.

The film protection layer 400 of the planar heater 300 according to an embodiment of the disclosure may further include a heat dissipation layer 430 arranged on the outer surface of at least one of the pair of metal protection layers 410. A heat dissipation layer 430 on the front metal protection layer is also referred to herein as a front heat dissipation layer, and a heat dissipation layer 430 on the rear metal protection layer is also referred to herein as a rear heat dissipation layer. Heat generated from the heating layer 310 may be uniformly released to the outside through the heat dissipation layer 430.

The heat dissipation layer 430 may be a layer coated with heat dissipation paint on the outer surface of the metal protection layer 410. The heat dissipation layer 430 may be formed by spraying or electrically attaching heat dissipation paint to the outer surface of the metal protection layer 410. Alternatively, the heat dissipation layer 430 may be manufactured on the metal protection layer 410 by using pre-coated metal (PCM). To increase the adhesion of the heat dissipation layer 430, the surface of the metal protection layer 410 facing the heat dissipation layer 430 may be surface-treated.

The material of the heat dissipation layer 430 may include at least one of carbon black or carbon nanotubes. However, the material of the heat dissipation layer 430 is not limited thereto and may be variously modified as long as the material has excellent heat dissipation performance.

The heat dissipation layer 430 may have a hardness greater than or equal to a predefined level. For example, the surface hardness of the heat dissipation layer 430 may be 2 H or more. For example, the surface hardness of the heat dissipation layer 430 may be 2 H to 10 H.

The heat dissipation layer 430 may have a predefined thickness or less. For example, the thickness of the heat dissipation layer 430 may be 40 μm or less. When the thickness of the heat dissipation layer 430 is greater than 40 μm, there is a risk that the heat dissipation layer 430 may break during a process of transporting or manufacturing the planar heater 300. The thickness of the heat dissipation layer 430 may be 1 μm to 40 μm.

As the heat dissipation layer 430 is arranged, the heat dissipation performance of the planar heater 300 may be improved. For example, the heat dissipation performance of the planar heater 300 may be improved up to 0.5 W/cm². The planar heater 300 may improve heat dissipation performance through the metal protection layer 410 and the heat dissipation layer 430. For example, when the planar heater 300 has a structure that does not include the metal protection layer 410 and the heat dissipation layer 430, the heat dissipation performance of the planar heater 300 may be 0.35 W/cm², which corresponds to the heat generation density of the heating layer 310. In contrast, when the planar heater 300 has a structure that further includes the metal protection layer 410 and the heat dissipation layer 430, the heat dissipation performance of the planar heater 300 may be increased up to 0.5 W/cm². When the planar heater 300 further includes the metal protection layer 410 and the heat dissipation layer 430, the heat dissipation density may be increase by 40 % or more, compared to the planar heater 300 that does not include the metal protection layer 410 and the heat dissipation layer 430.

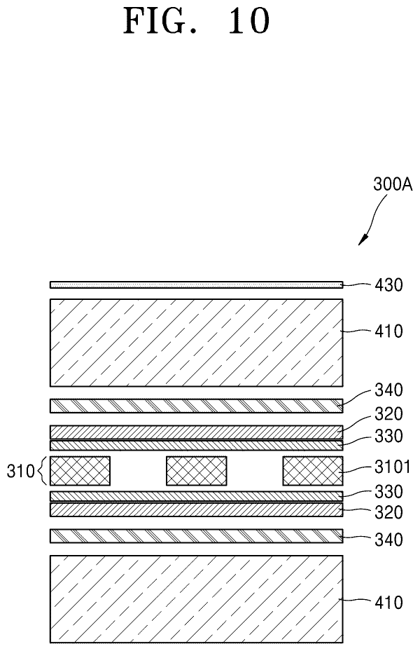

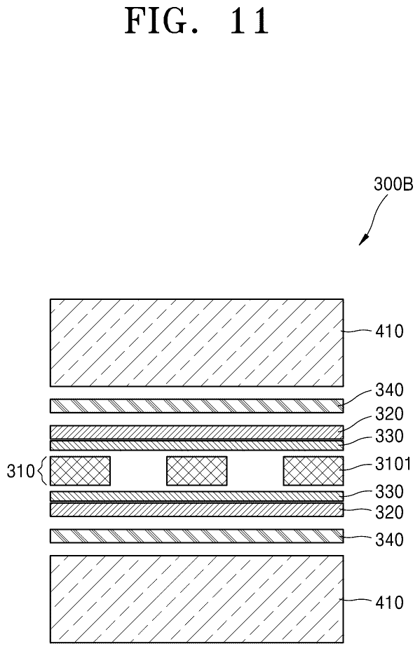

In the above-described embodiment of the disclosure, an example in which the heat dissipation layers 430 are respectively arranged on the outer surfaces of the plurality of metal protection layers 410 has been described. However, because the heat dissipation layer 430 of the planar heater 300 is optional, the heat dissipation layer 430 may be omitted when necessary. For example, in a planar heater 300A according to an embodiment of the disclosure, heat dissipation layers 430 may be arranged only on the outer surfaces of some of metal protection layers 410 and may not be arranged on the outer surfaces of the other metal protection layers 410, as illustrated in FIG. 10. For example, as illustrated in FIG. 11, a planar heater 300B according to an embodiment of the disclosure may not include a heat dissipation layer 430. In this case, the heat dissipation layer 430 of the planar heater 300B may not be arranged on the outer surfaces of the plurality of metal protection layers 410.

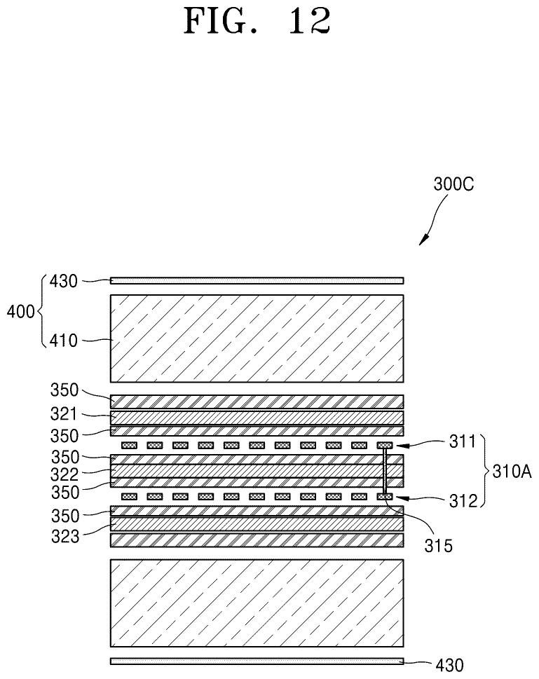

FIG. 12 is a diagram illustrating an example of a cross-sectional structure of a planar heater 300C according to an embodiment of the disclosure.

Referring to FIG. 12, a heating layer 310A of the planar heater 300C according to an embodiment of the disclosure may have a multilayer structure. For example, the heating layer 310A may include a first heating layer 311 and a second heating layer 312 arranged in the front-and-back direction of the planar heater 300C. In FIG. 12, a two-layer structure is illustrated as the multilayer structure of the heating layer 310A, but the disclosure is not limited thereto, and the heating layer 310A may have a structure of three or more layers.

Because the heating layer 310A has a multilayer structure, the length of the heating layer 310A may increase by the increased number of layers, and the increase in the length of the heating layer 310A may increase the resistance of the heating layer 310A. Accordingly, a heat generation amount of the heating layer 310A may be increased.

The first heating layer 311 and the second heating layer 312 may be electrically connected to each other. For example, the first heating layer 311 and the second heating layer 312 may be connected to each other by an C 315.

The planar heater 300C may include an insulating film layer 321 on the outer surface of the first heating layer 311, an insulating film layer 323 on the outer surface of the second heating layer 312, and an insulating film layer 322 between the first heating layer 311 and the second heating layer 312.

Adhesive layers 350 may be respectively arranged between the insulating film layer 321 and the first heating layer 311, between the first heating layer 311 and the insulating film layer 322, between the insulating film layer 322 and the second heating layer 312, and between the second heating layer 312 and the insulating film layer 323.

A metal protection layer 410 may be arranged on the outer surfaces of the insulating film layers 321 and 323, which is arranged on the outer surface of the heating layer 310A. This may prevent moisture from being transferred to the insulating film layer 321 and 323.

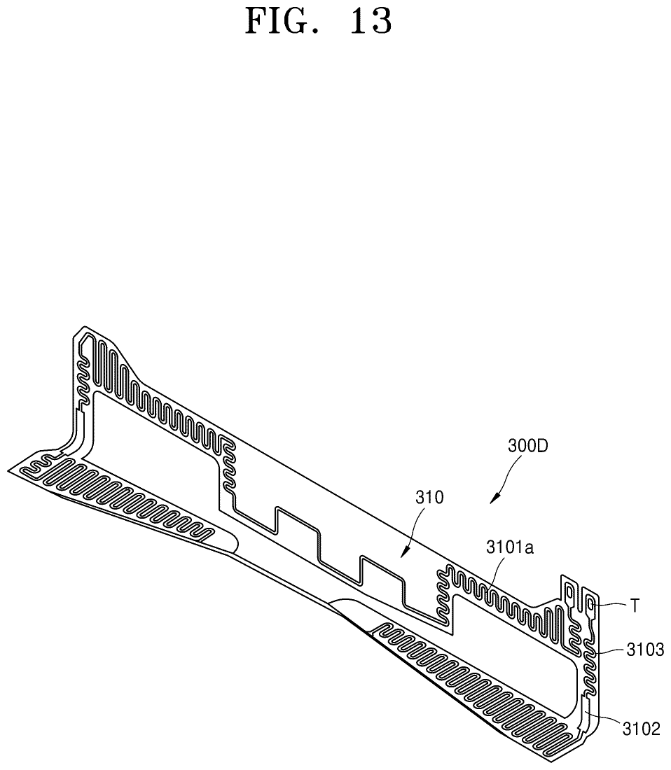

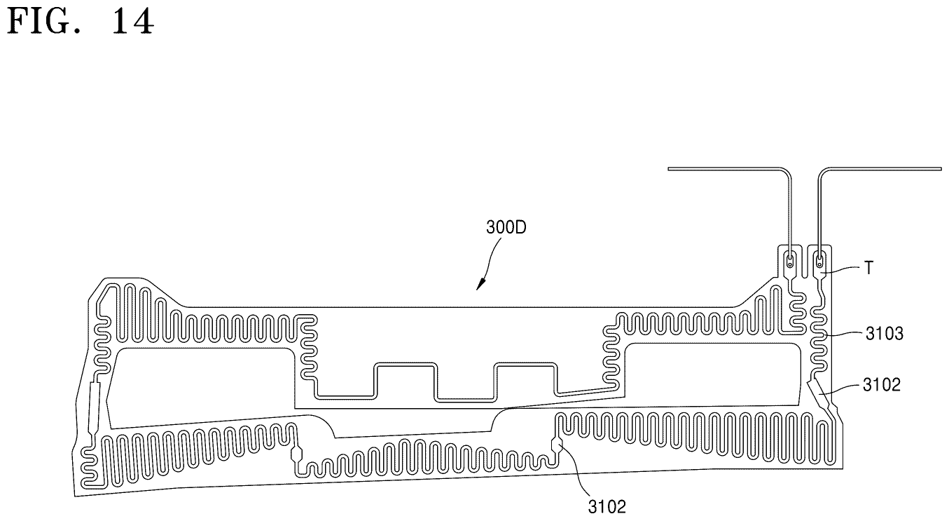

FIG. 13 is a perspective view illustrating an example of a planar heater 300D according to an embodiment of the disclosure, and FIG. 14 is a diagram illustrating a state before bending of the shape of the planar heater 300D of FIG. 13.

Referring to FIGS. 13 and 14, in the planar heater 300D according to an embodiment of the disclosure, a heating material 3101a of a heating layer 310 may extend in zigzags from a terminal T to which electric current is supplied. A portion of the planar heater 300D having the heating layer 310 may be bent.

When a heating material 3102 arranged in a bent portion and a heating material 3103 arranged in a non-bent portion have the same width, the resistance of the heating material 3102 arranged in the bent portion may increase. By taking into account the increase in the resistance of the heating material 3102 in the bent portion, the planar heater 300D according to an embodiment of the disclosure may be designed so that the width of the heating material 3102 arranged in the bent portion is large. The width of the heating material 3102 arranged in the bent portion of the planar heater 300D may be greater than the width of the heating material 3103 arranged in the non-bent portion. Due to this, even when the planar heater 300D is bent, the planar heater 300D may minimize the difference in heating temperature between the bent portion and the non-bent portion. The width of the heating material 3101a refers to a width in a direction perpendicular to the extension direction of the heating material 3101a in a plane on which the heating material 3101a is arranged.

The examples described above are merely exemplary, and various modifications and other equivalent embodiments of the disclosure may be made therefrom by those of ordinary skill in the art. Therefore, the true technical scope of protection of the disclosure should be determined by the technical concept of the disclosure set forth in the appended claims.

An aspect of the disclosure provides a planar heater capable of reducing the possibility of surface damage and a refrigerator including the planar heater.

An aspect of the disclosure provides a planar heater capable of improving the performance of the heater while reducing the possibility of surface damage and a refrigerator including the planar heater.

A planar heater according to an embodiment of the disclosure may include a heating layer having a front surface and rear surface; a front insulating film layer having an inner surface and an outer surface, the inner surface of the front insulating layer on the front surface of the heating layer; a rear insulating film layer having an inner and an outer surface, the inner surface of the rear insulating layer on the rear surface of the heating layer; a front film protection layer on the outer surface of the front insulating film layer and configured to externally transfer heat transferred from the front insulating film layer; and a rear film protection layer on the outer surface of the rear insulating film layer and configured to externally transfer heat transferred from the rear insulating layer. The front film protection layer may include a front metal protection layer on the outer surface of the front insulating film layer, and the rear film protection layer may include a rear metal protection layer on the outer surface of the rear insulating film layer.

The front metal protection layer may be larger than the front insulating film layer, the front metal protection layer may be larger the rear insulating layer, the rear metal protection layer may be larger than the front insulating layer, and the rear metal protection layer may be larger than the rear insulating layer, so that the front metal protection layer and the rear metal protection layer together cover the front insulating film layer and the rear insulating film layer.

A thickness of at least one of the front metal protection layer or the rear metal protection layer may be 0.15 mm to 0.3 mm.

A material of at least one of the front metal protection layer or the rear metal protection layer may include aluminum.

The front film protection layer may further include a front heat dissipation layer on a surface of the front metal protection layer opposite to the front insulating film layer and, the rear film protection layer may further include a rear heat dissipation layer on a surface of the rear metal protection layer opposite the rear insulating film layer.

A thickness of at least one of the front heat dissipation layer or the rear heat dissipation layer may be 1 μm to 40 μm.

A material of at least one of the front heat dissipation layer or the rear heat dissipation layer may be at least one of carbon black and carbon nanotubes.

At least one of the front insulating film layer or the rear insulating layer may include a polymer material.

The front insulating film layer and the rear insulating film layer may have heat resistance up to a temperature of 150° C.

The heating layer may include a heating material arranged in a line shape or a plane shape.

The heating layer may include a heating material, and the heating material may include a graphene material.

The heating layer may include a first heating layer and a second heating layer arranged in a front-and-back direction to have a multilayer structure, and the first heating layer and the second heating layer may be electrically connected to each other.

A portion of the planar heater may be bent, and a width of a heating material arranged in a bent portion of the planar heater may be greater than a width of a heating material arranged in a non-bent portion of the planar heater.

A refrigerator according to an embodiment of the disclosure may include a body portion having at least one storage compartment and a door configured to open or close the at least one storage compartment, and an evaporator provided in the body portion and configured to supply cold air to the at least one storage compartment.

The evaporator may include an evaporator module including a refrigerant tube through which a refrigerant moves and cooling fins arranged on an outer circumferential surface of the refrigerant tub, and the above-described planar heater arranged adjacent to the evaporator module and configured to heat the evaporator module.

According to an embodiment of the disclosure, the planar heater may reduce the possibility of surface damage through the film protection layer arranged on the outer surface of the insulating film layer.

According to an embodiment of the disclosure, the planar heater may reduce scratches from the outside by using the metal protection layers respectively arranged on the outer surfaces of the insulating film layers and may prevent moisture from permeating into the heating layer. The heat generated from the heating layer may be uniformly released to the outside through the heat dissipation layer.

Effects to be achieved by the disclosure are not limited to those described above, and other effects that are not described herein will be clearly understood from the following description by those of ordinary skill in the art.

1. A planar heater comprising:
a heating layer having a front surface and rear surface;
a front insulating film layer having an inner surface and an outer surface, the inner surface of the front insulating layer on the front surface of the heating layer;
a rear insulating film layer having an inner and an outer surface, the inner surface of the rear insulating layer on the rear surface of the heating layer;
a front film protection layer on the outer surface of the front insulating film layer and configured to externally transfer heat transferred from the front insulating film layer; and
a rear film protection layer on the outer surface of the rear insulating film layer and configured to externally transfer heat transferred from the rear insulating layer.

2. The planar heater of claim 1, wherein
the front film protection layer includes a front metal protection layer on the outer surface of the front insulating film layer, and
the rear film protection layer includes a rear metal protection layer on the outer surface of the rear insulating film layer.

3. The planar heater of claim 2, wherein
the front metal protection layer is larger than the front insulating film layer,
the front metal protection layer is larger the rear insulating film layer,
the rear metal protection layer is larger than the front insulating film layer, and
the rear metal protection layer is larger than the rear insulating film layer,
so that the front metal protection layer and the rear metal protection layer together cover the front insulating film layer and the rear insulating film layer.

4. The planar heater of claim 2, wherein a thickness of at least one of the front metal protection layer or the rear metal protection layer is 0.15 mm to 0.3 mm.

5. The planar heater of claim 2, wherein a material of at least one of the front metal protection layer or the rear metal protection layer is aluminum.

6. The planar heater of claim 2, wherein
the front film protection layer further includes a front heat dissipation layer on a surface of the front metal protection layer opposite to the front insulating film layer and,
the rear film protection layer further includes a rear heat dissipation layer on a surface of the rear metal protection layer opposite the rear insulating film layer.

7. The planar heater of claim 6, wherein a thickness of at least one of the front heat dissipation layer or the rear heat dissipation layer is 1 μm to 40 μm.

8. The planar heater of claim 6, wherein a material of at least one of the front heat dissipation layer or the rear heat dissipation layer is at least one of carbon black and carbon nanotubes.

9. The planar heater of claim 1, wherein at least one of the front insulating film layer or the rear insulating layer includes a polymer material.

10. The planar heater of claim 9, wherein the front insulating film layer and the rear insulating film layer has heat resistance up to a temperature of 150 °C.

11. The planar heater of claim 1, wherein the heating layer includes a heating material arranged in a line shape or a plane shape.

12. The planar heater of claim 1, wherein the heating layer includes a heating material, and the heating material includes a graphene material.

13. The planar heater of claim 1, wherein the heating layer includes a first heating layer and a second heating layer arranged in a front-and-back direction to have a multilayer structure, and
the first heating layer and the second heating layer are electrically connected to each other.

14. The planar heater of claim 1, wherein the heating layer includes a heating material, a portion of the planar heater is bent, and
a width of the heating material in a bent portion of the planar heater is greater than a width of the heating material arranged in a non-bent portion of the planar heater.

15. A refrigerator comprising:
a body portion having at least one storage compartment and a door configured to open or close the at least one storage compartment;
an evaporator in the body portion, configured to supply cold air to at least one storage compartment, and including an evaporator module, the evaporator module including a refrigerant tube through which a refrigerant moves, cooling fins arranged on an outer circumferential surface of the refrigerant tube; and
a planar heater adjacent to the evaporator module, configured to heat the evaporator module, and including:
a heating layer having a front surface and rear surface,
a front insulating film layer having an inner surface and an outer surface, the inner surface of the front insulating layer on the front surface of the heating layer,
a rear insulating film layer having an inner and an outer surface, the inner surface of the rear insulating layer on the rear surface of the heating layer,
a front film protection layer on the outer surface of the front insulating film layer and configured to externally transfer heat transferred from the front insulating film layer, and
a rear film protection layer on the outer surface of the rear insulating film layer and configured to externally transfer heat transferred from the rear insulating layer.
